(19) United States
(12) Patent Application Publication
(10) Pub. No.: US 2026/0128197 A1
(43) Pub. Date: May 7, 2026

(54) CABLE TERMINATION COVERS

(71) Applicant: Hubbell Incorporated, Shelton, CT (US)

(72) Inventors: Kris Robin Boutin, Mont Vernon, NH (US); Nolan John Bell, Nashua, NH (US)

(21) Appl. No.: 19/369,647

(22) Filed: Oct. 27, 2025

Related U.S. Application Data
(60) Provisional application No. 63/717,373, filed on Nov. 7, 2024.

(51) Int. Cl. H01B 17/58

(52) U.S. Cl. CPC H01B 17/58

(57) ABSTRACT

A cable termination cover includes a tubular body dimensioned to receive a cable termination and at least partially filled with a protective material and a pair of attachment points. A strap includes a pair of arms, the strap for extending between a pair of cables forming a portion of the cable termination and wherein the strap is configured to be attached to the pair of attachment points.

### CROSS-REFERENCE TO RELATED APPLICATIONS

This application claims priority to U.S. Provisional Application Ser. No. 63/717,373 filed Nov. 7, 2024 entitled CABLE TERMINATION COVERS the contents of which are incorporated herein in their entirety by reference.

### BACKGROUND

### Field

The present disclosure relates to cable covers and, more specifically, to cable termination covers.

### Description of the Related Art

Electrical cables are used to connect all types of electrical equipment. Often, two or more cable terminations are connected together. The insulation is removed from the end of the cables to expose the conductors and the bare conductors are joined. Various types of methods may be used to connect the bare conductors, depending on a particular application. Non-limiting examples of such methods include crimping, use of lugs, soldering, etc. Various types of lugs exist for connecting two or more cables. These include but are not limited to compression lugs, crimp-on lugs, set-screw lugs, solder lugs, hammer-on lugs, etc. The lugs may be joined using one or more fasteners such as, for example, nuts and bolts, etc. After the cables are joined, the exposed portions generally need to be reinsulated to protect them from shorting out and to protect the exposed portions from the environment and its effects.

Various types of methods are used to reinsulate joined cables. These include, for example, the use of heat shrink tubing, wraps such as tape, etc., liquid insulating dips, etc. Another method of reinsulating joined cables utilizes a tube or sleeve including an insulating material. The exposed portions of the joined cables are seated in the tube or sleeve so that the insulating material engulfs the exposed portions. A clamp or crimp retaining ring may be wrapped around the tube or sleeve clamping the sleeve to the joined cables.

While the clamp or crimp retaining ring may be effective in the short term, the clamp may tend to loosen over time reducing its effectiveness. While the use of a crimp retaining ring results in more permanent attachment, it can be difficult to remove the crimp retaining ring from the tube or sleeve should the need arise. Existing clamps and crimp retaining rings require the use of one or more tools.

### SUMMARY

The present disclosure provides embodiments of cable termination covers including a tubular body dimensioned to receive a cable termination and at least partially filled with a protective material and a pair of attachment points. A strap includes a pair of arms, the strap for extending between a pair of cables forming a portion of the cable termination and wherein the strap is configured to be attached to the pair of attachment points.

According to another illustrative embodiment of the present disclosure the cable termination cover includes a sleeve including a tubular body dimensioned to receive a cable termination terminating at least a pair of cables, a pair of attachment points, each provided on an opposite outside surface of the tubular body, and a moisture resistant seal material at least partially filling the tubular body. A strap includes a loop and a pair of arms, the strap configured to extend between the pair of cables of the cable termination and wherein the pair of arms are configured to be attached to the pair of attachment points.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1A is a perspective view of cables to be joined;

FIG. 1B is a perspective view of the joined cables;

FIG. 2A is a perspective view of a cable termination cover according to an illustrative embodiment of the present disclosure;

FIG. 2B is a side elevation view of the cable termination cover according to an illustrative embodiment of the present disclosure;

FIG. 2C is a top plan view of the cable termination cover according to an illustrative embodiment of the present disclosure;

FIG. 2D is a bottom plan view of the cable termination cover according to an illustrative embodiment of the present disclosure;

FIG. 3A is a top plan view of a strap for the cable termination cover according to an illustrative embodiment of the present disclosure;

FIG. 3B is a perspective view of the strap for the cable termination cover according to an illustrative embodiment of the present disclosure;

FIGS. 4A-4C are perspective views of the cable termination cover, strap and cable bundle for describing aspects of the present disclosure;

FIG. 5 is a cross-sectional view of the cable termination cover, strap and cable bundle as shown in FIG. 4C, taken along lines 5-5 according to an illustrative embodiment of the present disclosure; and

FIG. 6 is a perspective view of a cable termination cover according to another illustrative embodiment of the present disclosure.

### DETAILED DESCRIPTION

The present disclosure provides embodiments of cable termination covers used to protect electrical cable termination connections from the environment and its effects. For ease of description, the cable termination cover may be referred to as the “cover” in the singular and “covers” in the plural. The electrical cable termination connections may be referred to as the “cable termination” in the singular and “cable terminations” in the plural. The joined ends of the cables may be referred to as the cable end bundle.

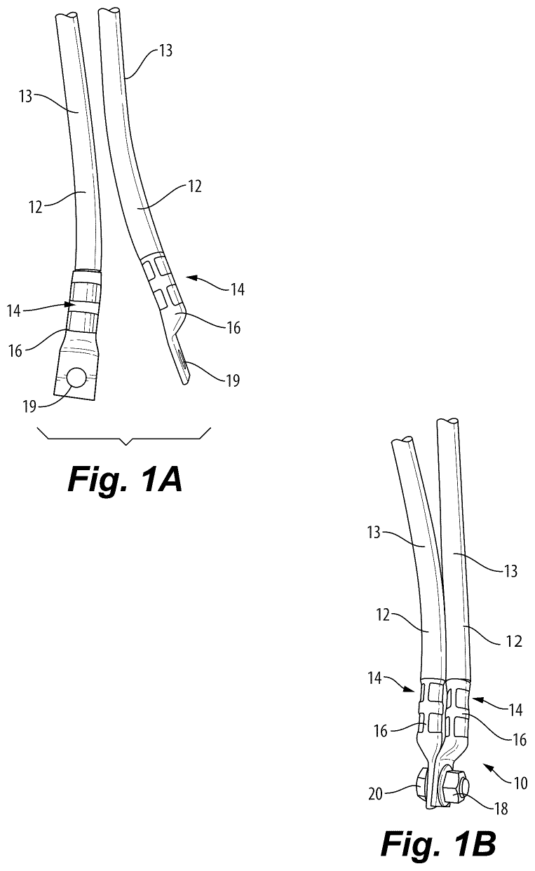

A set of cables to be joined is shown in FIGS. 1A and 1B. While the cables are depicted as being the same size or gauge for illustration and description purposes, it will be appreciated the cables may be of different sizes or gauges. Furthermore, although two cables are shown, it will be appreciated that aspects of the present disclosure may be practiced on three or more cables being joined. Each cable 12 may be formed with stranded or solid conductors and generally include at least one layer of insulation 13. The insulation layer or layers 13 are removed from distal ends 14 of each cable 12 to expose the bare conductors. Lugs 16 are then crimped to or otherwise attached to the bare distal ends 14 of the conductors in any suitable known manner. Lugs 16 include holes 19. Lugs 16 are placed back-to-back as shown in FIG. 1B and a bolt 20 is passed through holes 19 in the lugs and secured with a nut 18 joining the lugs 16 together in forming a cable end bundle 10.

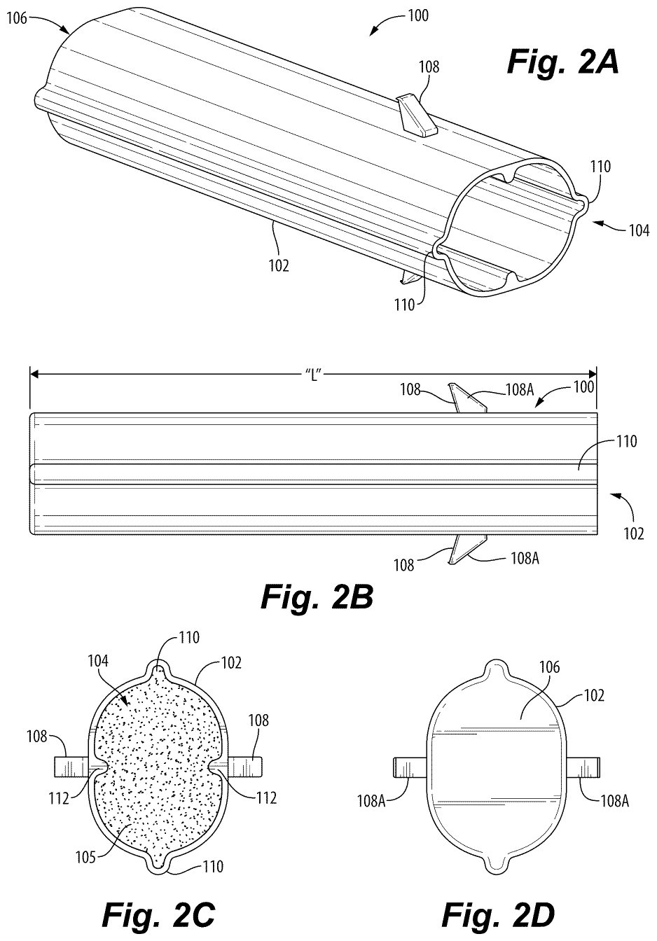

According to an illustrative embodiment of the present disclosure the joined ends of cables 12 (e.g., cable end bundle 10) are protected from the environment and its effects, utilizing a sleeve 100 as depicted in FIGS. 2A-2D. The sleeve 100 is at least partially filled with a protective material 105. The cable end bundle 10 is inserted into the sleeve 100 such that the protective material 105 engulfs the cable end bundle 10. Preferably, the length (“L”) of the sleeve 100 and the amount of protective material 105 provided in the sleeve 100 are sufficient such that the entire cable end bundle 10 and portions of the still insulated cables 12 are engulfed in the protective material 105.

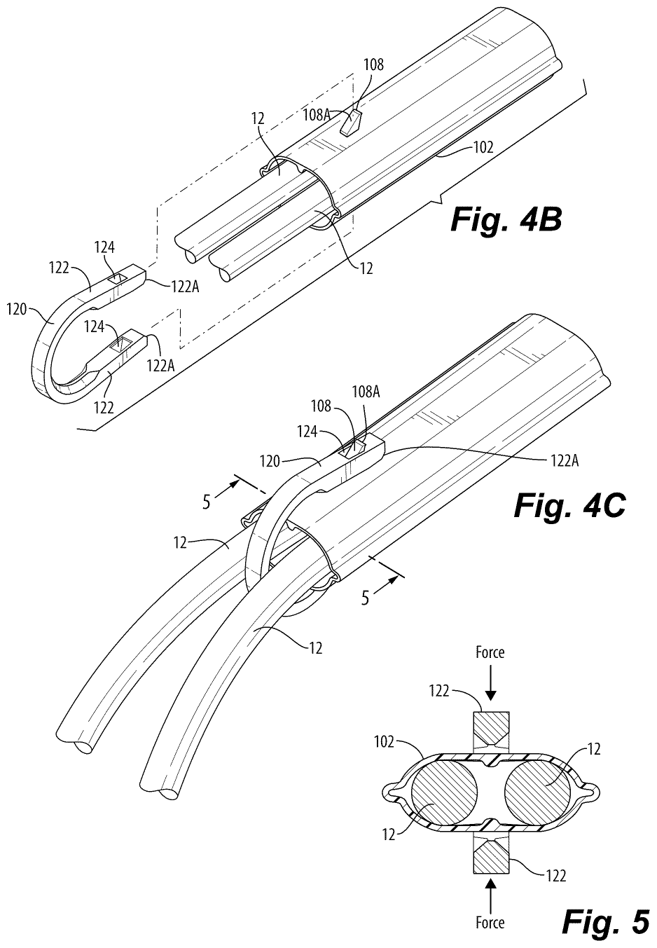

Sleeve 100 has a tubular body 102 having an open top 104 and a closed bottom 106. According to the embodiment depicted in FIGS. 2A-2D, the tubular body 102 is substantially oval in horizontal cross-section as shown in the top view of FIG. 2C and dimensioned to receive the cable end bundle 10 (e.g., the joined ends of cables 12). Opposite side surfaces of tubular body 102 each include clips 108 to which a securing strap 120 is attached as will be described later below by reference to FIGS. 4A-4C. The upper edges 108A of clips 108 are angled as shown. The tubular body 102 includes longitudinal grooves 110 which provide freedom for the tubular body 102 to flex. In particular, the tubular body 102 can expand when the joined ends of cables 12 are inserted into the tubular body 102 and allows the tubular body 102 to compress against the cables 12 when the securing strap 120 is attached to the tubular body 102. The inside surface of tubular body 102 includes one or more longitudinal ribs 112 which rest in the crotch of the cable bundle 10 limiting rotational movement of the cable bundle 10 within the tubular body 102.

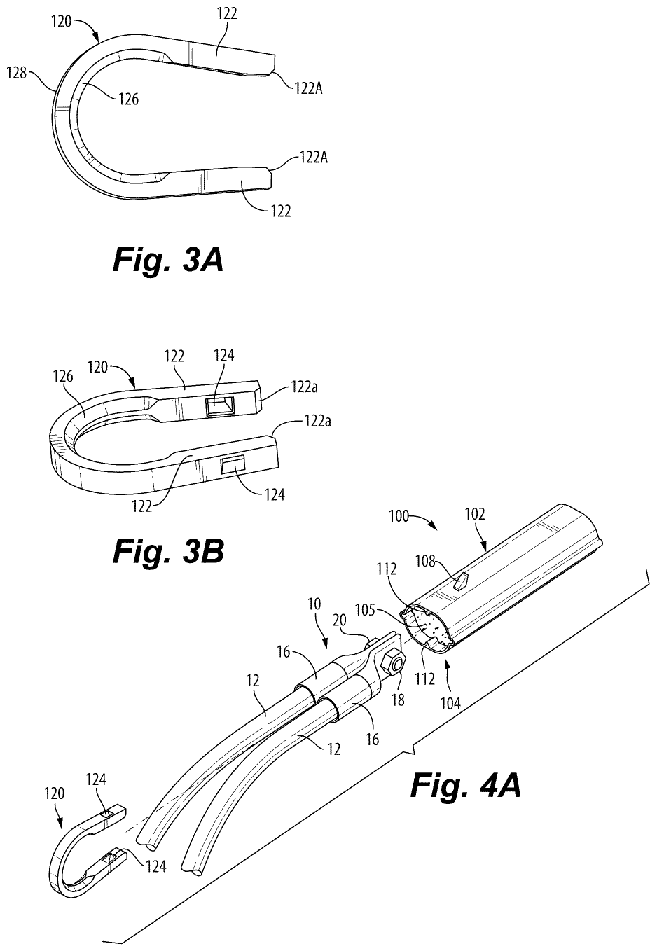

In order to secure the sleeve 100 to the cable end bundle 10, a securing strap 120 as depicted in FIGS. 3A, 3B is utilized. Securing strap 120 is a substantially C-shaped or horseshoe shaped member having a loop 128 and legs 122. The inside edges 126 of loop 128 are beveled as shown. The inside distal edges 122A of end legs 122 are also beveled as shown. End legs 122 include notches or orifices 124 extending at least partially therethrough. The notches or orifices 124 are dimensioned and positioned to receive the clips 108 extending from the sides of tubular body 102. According to another embodiment of the present disclosure, the notches or orifices 124 may be provided in the sides of tubular body 102 and the clips 108 may be provided extending inward from the legs 122.

As shown in FIGS. 4A-4C, the cable end bundle 10 is inserted into the tubular body 102 of sleeve 100 until the cable end bundle 10 is properly seated in the protective material 105 provided in sleeve 100. The longitudinal ribs 112 provided on the inside surfaces of tubular body 102 rest in the gap or crotch between the lugs 16 and cables 12, securing the cable bundle 10 in position and limiting rotational movement of the cable bundle 10 within sleeve 100. The cable end bundle 10 is properly positioned within sleeve 100 when the lugs 16 and at least a portion of the still insulated portions of cables 12 are completely engulfed by the protective material 105 in sleeve 100. This can be confirmed by a visual inspection from the open top 104 of the sleeve 100. The securing strap 120 is then positioned between cables 12 and slid down onto sleeve 100. Depending on the thickness of the walls of the tubular body 102 and the material it is formed of, as the securing strap 120 is slid down onto sleeve 100, the sides of the tubular body 102 may compress toward each other from the inward force of the securing strap 120 effectively clamping the tubular body 102 to the cables 12 (e.g., see FIG. 5). As the strap 120 is further slid down onto sleeve 100, the tapered inside distal edges 122A of arms 122 contact the upper angled edges 108A of clips 108 spreading the arms 122 of strap 120 until clips 108 “snap” into the notches 124 of arms 122. The beveled inside edges 126 of strap 120 prevent any sharp edges from cutting or wearing on the cables 12.

The cable end bundle 10 may be readily removed from sleeve 102 by spreading arms 122 of strap 120 until the clips 108 are clear of the notches 124 of arms 122 and withdrawing the strap 120. The cable end bundle 10 can then be withdrawn from the sleeve 102.

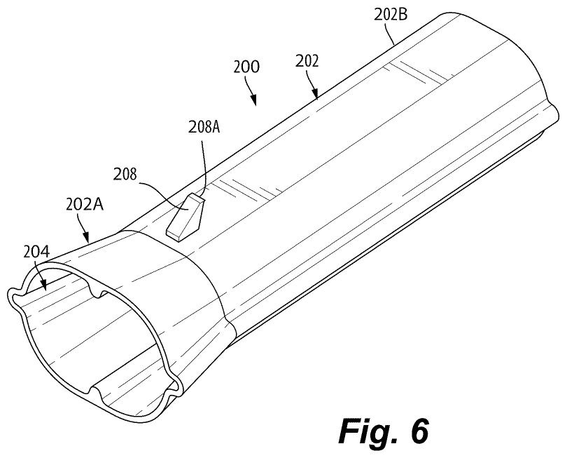

Sleeve 100 may take other shapes and sizes than that depicted in FIGS. 2A-5. That is, the shape of the tubular body 102 may be other than oblong in cross-section and may not be the same shape or configuration along its entire longitudinal length. For example, the tubular body 102 may be substantially round, square, rectangular, etc. to suit a particular application. A sleeve 200 according to another illustrative embodiment of the present disclosure is depicted in FIG. 6. In this embodiment, the distal end portion 202A of tubular body 202 is shaped differently than the proximal end portion 202B. In particular, the proximal end portion 202B is shaped similar to the tubular body 102 described above with respect to FIGS. 2A-5. The distal end portion 202A tapers or flairs outwardly providing a larger opening 204 to tubular body 202. The larger opening 204 allows room for three or more cables 12 to be joined in a cable end bundle. The cable end bundle joining the three or more cables can be easily inserted into the proximal end portion 202B of tubular body in a manner similar to that described above with respect to previous embodiments thus protecting the cable end bundle 10 from the elements and their effects. Sleeve 200 includes clips 208 having angled surfaces 208A for receiving a strap similar to strap 120 described above.

According to an illustrative embodiment of the present disclosure, the protective material 105 is a gel. In particular, the protective material 105 is a dielectric gel material that insulates and protects the otherwise exposed cable end bundle 10. Preferably, the material provides a moisture seal over a wide range of temperatures. An example of such a material is the self-healing silicon gel Begel 8710-2 manufactured by Shanghai Beginor Chemical Technology Co., Ltd.

The sleeves and/or straps described herein may be formed from any suitable type of material capable of withstanding exposure to the environment and its effects. Non-limiting examples of such materials include polyvinyl chloride (PVC), acrylonitrile butadiene styrene (ABS), polylactic acid (PLA), high impact polystyrene (HIPS), thermoplastic elastomers (TPEs), polyethylene, etc.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. A cable termination cover comprising:
a sleeve comprising,
a tubular body dimensioned to receive a cable termination and at least partially filled with a protective material, and
a pair of attachment points; and
a strap comprising a pair of arms, the strap for extending between a pair of cables forming a portion of the cable termination and wherein the strap is configured to be attached to the pair of attachment points.

2. The cable termination cover according to claim 1, wherein the tubular body comprises a longitudinal axis and is substantially oblong in lateral cross-section.

3. The cable termination cover according to claim 1, wherein the strap further comprises beveled inner edges.

4. The cable termination cover according to claim 1, wherein the tubular body comprises at least one internal longitudinal groove.

5. The cable termination cover according to claim 1, wherein the tubular body comprises at least one internal longitudinal rib.

6. The cable termination cover according to claim 1, wherein the pair of attachment points comprise at least one of a notch and a clip.

7. The cable termination cover according to claim 6, wherein the strap is configured with at least one of a notch and a clip to be attached to the pair of attachment points on the sleeve.

8. The cable termination cover according to claim 1, wherein the protective material comprises a dielectric gel.

9. The cable termination cover according to claim 8, wherein the dielectric gel provides a moisture seal over a wide range of temperatures.

10. A cable termination cover comprising:
a sleeve comprising,
a tubular body dimensioned to receive a cable termination terminating at least a pair of cables,
a pair of attachment points, each provided on an opposite outside surface of the tubular body, and
a moisture resistant seal material at least partially filling the tubular body; and
a strap comprising a loop and a pair of arms, the strap configured to extend between the pair of cables of the cable termination and wherein the pair of arms are configured to be attached to the pair of attachment points.

11. The cable termination cover according to claim 10, wherein the tubular body comprises a longitudinal axis and is substantially oblong in lateral cross-section.

12. The cable termination cover according to claim 10, wherein the strap further comprises beveled surfaces along inside edges of the loop.

13. The cable termination cover according to claim 10, wherein the tubular body comprises at least one internal longitudinal groove.

14. The cable termination cover according to claim 10, wherein the tubular body comprises at least one internal longitudinal rib.

15. The cable termination cover according to claim 10, wherein the pair of attachment points comprise at least one of a notch and a clip.

16. The cable termination cover according to claim 15, wherein the strap is configured with at least one of a notch and a clip to be attached to the pair of attachment points on the sleeve.

17. The cable termination cover according to claim 10, wherein the moisture resistant material comprises a dielectric gel.

18. The cable termination cover according to claim 17, wherein the dielectric gel provides a moisture seal over a wide range of temperatures.
